(19) United States
(12) Patent Application Publication
(10) Pub. No.: US 2009/0147272 A1
(43) Pub. Date: Jun. 11, 2009

(54) PROXIMITY DETECTION FOR CONTROL OF AN IMAGING DEVICE

(75) Inventors: Gregory T. Gibson, Snohomish, WA (US); Joshua M. Hudman, Redmond, WA (US); Randall B. Sprague, Hansville, WA (US)

Correspondence Address: MICROVISION, INC., 6222 185TH AVENUE NE, REDMOND, WA, 98052, US

(73) Assignee: Microvision, Inc., Redmond, WA (US)

(21) Appl. No.: 11/950,639

(22) Filed: Dec. 5, 2007

(51) Int. Cl. G01B 11/14; G03B 21/14

(52) U.S. Cl. 356/623; 353/122

(57) ABSTRACT

Briefly, in accordance with one or more embodiments, a proximity detector is placed proximate to projector to detect an obstruction disposed proximate to the projector. The proximity detector is capable of estimating the distance from an object to the projector. If an object is detected within a minimum distance, the projector operation may be altered, for example to cause the projector to turn off, or to reduce the intensity of emitted light so that the power of the emitted light the minimum distance will be reduced to below a selected range. Furthermore, if an object cannot be detected within or near a maximum distance, the projector operation may likewise be altered, for example the proximity detector may cause the projector to turn off.

### BACKGROUND

Mobile devices, such as cell phones and personal digital assistants, provide many features to their users outside of those necessary for telecommunications. One feature that has been proposed for mobile devices is a projector, such as a scanned beam imaging device that projects images. Projectors are small enough to be placed in the mobile device, yet are powerful enough to show bright, full color images to users. Being able to project images and video that are significantly larger than the screen of the mobile device greatly enhances the value and usability of the mobile device to a user.

When a projector is incorporated into a mobile device and/or various other applications, it may be helpful to ensure that the projector operates in a normal and effective manner. Scanned beam imaging devices using image projecting elements such as lasers are typically regulated and placed into classes organized by maximum permissible exposure. Generally, these classes range from Class 1 to Class 4, where Class 1 and Class 2 lasers generate exposure that is non-harmful to a person, specifically to a human eye. However, in order to be effective in projecting images that are sufficiently bright for viewing, scanned beam projectors may output a narrow beam at a higher level of optical power. It is contemplated that at certain distances, the narrow beam and relatively higher optical power may cause an optical power density to be above the standards of Class 1 or Class 2 lasers. Reducing the beam power and/or widening the beam may result in an image that is not sufficiently viewable for the intended purpose of the projector.

### DESCRIPTION OF THE DRAWING FIGURES

Claimed subject matter is particularly pointed out and distinctly claimed in the concluding portion of the specification. However, such subject matter may be understood by reference to the following detailed description when read with the accompanying drawings in which:

FIG. 1 is a block diagram illustrating a device containing a projector and accompanying components in accordance with one or more embodiments;

FIG. 2 is a block diagram illustrating a device employing a projection module with proximity detection features in accordance with one or more embodiments;

FIG. 3 is a block diagram illustrating a projection module and projected image cone in accordance with one or more embodiments;

FIG. 4 is a flow diagram of a routine for determining if a laser in the projection module should be reduced in power or turned off as a proximity detection mechanism in accordance with one or more embodiments;

FIG. 5 is a block diagram illustrating a proximity detector that uses periphery detection in accordance with one or more embodiments;

FIGS. 6A-6D are block diagrams illustrating the operation of the periphery detection proximity detector in accordance with one or more embodiments;

FIG. 7 is an exploded diagram illustrating a proximity detection module that uses periphery detection in accordance with one or more embodiments;

FIG. 8 is a block diagram illustrating a proximity detector that uses triangulation-based distance estimation in accordance with one or more embodiments;

FIGS. 9A-9E are block diagrams illustrating the operation of an triangulation-based proximity detector in accordance with one or more embodiments;

FIG. 10 is a cross-section of a mounting fixture for the triangulation-based proximity detector in accordance with one or more embodiments;

FIG. 11 is a block diagram illustrating an alternative embodiment of a proximity detector that uses periphery detection in accordance with one or more embodiments;

FIG. 12 is a block diagram illustrating the operation of the embodiment of a proximity detector as shown in FIG. 11 in accordance with one or more embodiments;

FIG. 13 is a plot of the output of a linear array of a proximity detector in accordance with one or more embodiments;

FIG. 14 is a plot of the output of a linear array of a proximity detector showing the output of the linear array if an object is disposed proximate to a projector in accordance with one or more embodiments;

FIG. 15 is a plot of the output of the linear array of a proximity detector showing the output of a failure detection mechanism in accordance with one or more embodiments; and

FIG. 16 is a block diagram of a device having a projector and a proximity detector showing the control of the projector by the proximity detector in accordance with one or more embodiment.

It will be appreciated that for simplicity and/or clarity of illustration, elements illustrated in the figures have not necessarily been drawn to scale. For example, the dimensions of some of the elements may be exaggerated relative to other elements for clarity. Further, if considered appropriate, reference numerals have been repeated among the figures to indicate corresponding and/or analogous elements.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

In the following description and/or claims, the terms coupled and/or connected, along with their derivatives, may be used. In particular embodiments, connected may be used to indicate that two or more elements are in direct physical and/or electrical contact with each other. Coupled may mean that two or more elements are in direct physical and/or electrical contact. However, coupled may also mean that two or more elements may not be in direct contact with each other, but yet may still cooperate and/or interact with each other. For example, “coupled” may mean that two or more elements do not contact each other but are indirectly joined together via another element or intermediate elements. Finally, the terms “on,” “overlying,” and “over” may be used in the following description and claims. “On,” “overlying,” and “over” may be used to indicate that two or more elements are in direct physical contact with each other. However, “over” may also mean that two or more elements are not in direct contact with each other. For example, “over” may mean that one element is above another element but not contact each other and may have another element or elements in between the two elements. Furthermore, the term “and/or” may mean “and”, it may mean “or”, it may mean “exclusive-or”, it may mean “one”, it may mean “some, but not all”, it may mean “neither”, and/or it may mean “both”, although the scope of claimed subject matter is not limited in this respect. In the following description and/or claims, the terms “comprise” and “include,” along with their derivatives, may be used and are intended as synonyms for each other.

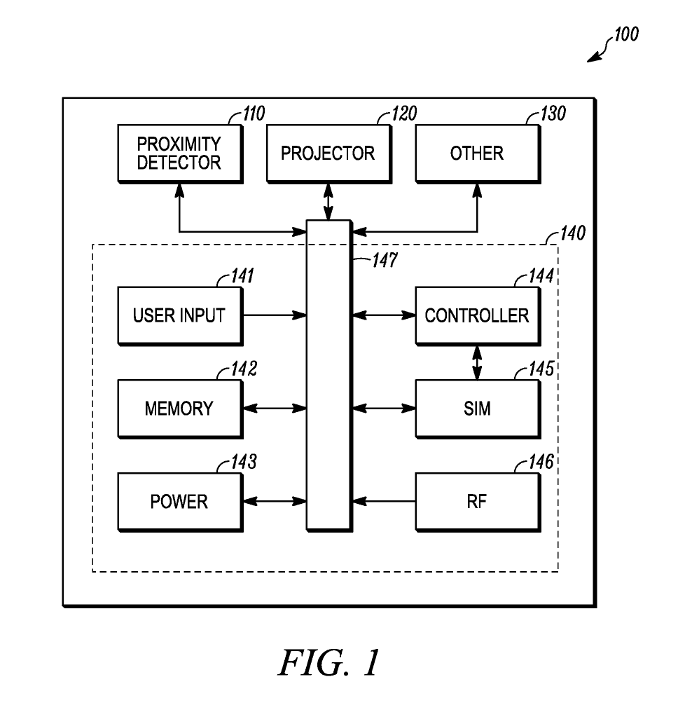

Referring now to FIG. 1, a block diagram illustrating a device containing a projector and accompanying components in accordance with one or more embodiments will be discussed. FIG. 1 illustrates a suitable device 100 such as a mobile device or the like in which a projector 120 and proximity detector 110 may be implemented. The device 100 contains a projector 120, such as a scanned beam imaging device that uses a microelectromechanical system (MEMS) mirror to scan a beam across two directions to form a projected image. The device 100 may also contain other components 130, such as memory components or other components that collaborate with the projector 120 or the proximity detector 110. Device 100 may comprise a mobile phone, mobile email device, portable media player, personal digital assistant, laptop or other mobile computer, digital camera, or any other device that may be benefited by the inclusion of a projector, although the scope of the claimed subject matter is not limited in this respect.

The device 100 may also contain components 140 that provide telecommunications functionality of the device 100 and assist in the functionality of the projector 120 and/or proximity detector 110. For example, device 100 may contain a radio-frequency (RF) circuit 146 that is capable of communicating via RF signals and is capable of receiving a transmitted signal via an antenna and reconstructing the original transmitted signal. The received signal may be sent to a controller 144, which may comprise a decoder, a processor, and Random Access Memory (RAM), or the like. The output of the controller 144 may be stored in a programmable non-volatile memory 142 or in the RAM memory. The controller translates the signals into meaningful data and interfaces to other components via a bus 147. Commands and other interface information may be received from user input component 141 and sent to the controller 144. The device may also include a subscriber identity module (SIM) 122. In addition, the device 100 may include additional components, such as a power component 143 that powers the device 100, including the proximity detector 110 and the projector 120. In one or more embodiments, proximity detector 110 is capable of detecting an object disposed at a predetermined distance or less from device 100 via triangulation as discussed herein, below. In addition to the infrared, triangulation based sensors described herein, other sensors may of course be implemented. For example, they may be other triangulation based sensors, reflection based sensors such as sound wave or electromagnetic wave based components, imaging sensors such as closed loop sensors and so on, and the scope of the claimed subject matter is not limited in this respect.

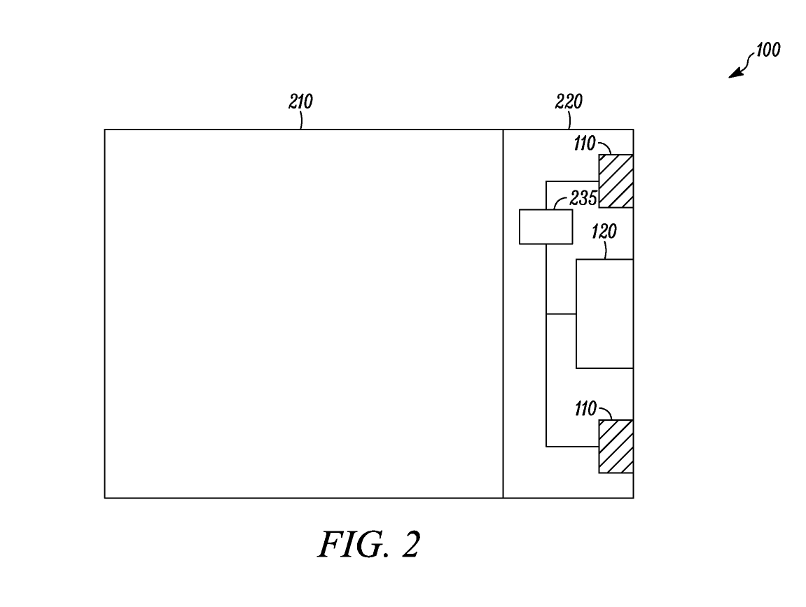

Referring now to FIG. 2, a block diagram illustrating a device employing a projection module with proximity detection features in accordance with one or more embodiments will be discussed. FIG. 2 is a top cross-sectional diagram of a device 100 that includes a projector 120 and proximity detector 110. The majority of the device packaging may be occupied by telecommunications components 210, while a projection module 220 is placed at one end of the device 100 such as at the top or end of the device. The projection module 220 contains a projector 120 that projects an image or series of images from the device onto a projection surface such as a wall, a screen, or the like, and a proximity detector 110 that ensures the normal operation of the projector 120 by detecting if an object interposed between projector 120 and the projection surface, for example.

In some cases, the proximity detector 110 comprises an infrared (IR) radiation emitter and a reflected light detector. As will be discussed in additional detail herein, these may include, but are not limited to, an infrared emitter, beam splitting elements, and a linear array of detectors, or two or more sensors that are placed near the projector 120 on either side of the projector 120 at a known, but not necessarily equal, distance. The projection module 220 contains a controller 235 that controls the projector 120 and the proximity detector 110. In some cases, another component of the device 100, such as the controller 144, may control or partially control the projector 120 and/or proximity detector 110. For the remainder of this description, a coordinate system will be used that is centered on the projection module. In one or more embodiments, references to “left” or “right” are measured from the point of view of the projector and/or with respect to the direction of light propagation.

Although the projection module 220 is discussed in conjunction with a device, the projection module 220 may be employed in other devices. For example, head-up displays (HUDs), media players, and other devices may employ the projection module 220. In addition, some or all aspects of the proximity detector 110 may be employed by devices other than mobile devices. Examples include other laser-based devices, other imaging devices, or any devices that may determine whether an object is within a certain distance and/or area from the device.

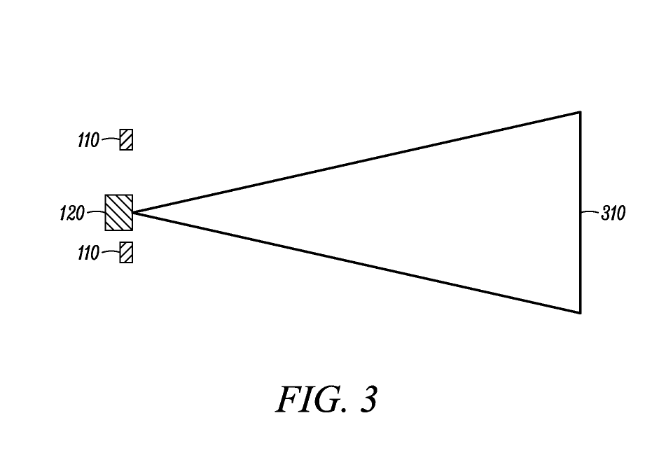

Referring now to FIG. 3, a block diagram illustrating a projector 120 and a proximately placed proximity detector 110 in accordance with one or more embodiments will be discussed. The projector 120 projects an image over an area within a projection cone 310 defined by the technology of the projector 120 and/or the geometry of the device housing. The proximity detector 110 is located proximate to the projector 120, and may be disposed at one or more positions and/or geometries near or about projector 120, and detects when an object or objects at least partially enter an area within or near the projection cone 310 that is considered undesirable for objects to be so disposed. The proximity detector 120 also detects the presence or absence of a surface on which to project the image. When an object is detected as entering the operating range of projector 120, or when other undesirable conditions exist for the projection of an image, for example when no surface is detected in front of projector 120, the proximity detector 110 regulates the output of the projector 120 to ensure that no undesirable effects occur to the object and/or to viewers of the image. For example, if the object entering the operating range of projector 120 was a human eye, the output of the projector 120 could be turned off so no light impacted on the eye, or reduced to a level where the light impacting on the eye would be at a normal level.

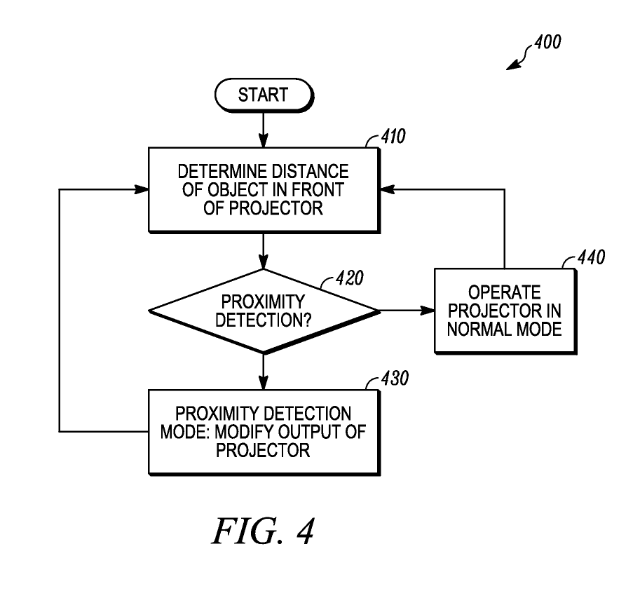

Referring now to FIG. 4, a flow diagram illustrating a routine 400 that is implemented by the controller in order to regulate the operation of the projector in accordance with one or more embodiments will be discussed. In step 410, the controller estimates the distance of an object in front of the projector using emission signals from the proximity detector. In decision step 420, the controller determines if the detected object is within a range that indicates a proximity detection mode of operation is warranted. If the detected object is not found to be within a predetermined range that would warrant a normal mode of operation, processing continues to a step 440. At step 440, the projector is allowed to continue to operate in a normal mode of operation.

If the detected object is found to be within a predetermined range requiring a proximity detection mode of operation at step 420, processing continues to step 430. In step 430, the controller issues a command or otherwise causes the projection of images from the projector to be modified. In some cases, the controller causes the projector to be turned off. In some cases, the controller causes the power of the projector to be reduced to a level that produces a satisfactory exposure level at the determined distance. After the projector is caused to enter a normal mode of operation, processing returns to step 410. At step 410, the distance of the object is re-measured. As long as the object remains within the predetermined range, the projector will be controlled to ensure that it continues to operate in the proximity detection mode of operation. If, however, the object moves outside of the predetermined range, at step 440 a command will be issued by the controller to cause the projector to return to a normal mode of operation.

The estimation of the distance of the object in front of the projector 410 may be performed on a continuous basis or on a periodic basis. The frequency of distance estimation may be based on the output power of the projector, the distance of the object, or both. For example, if an object is detected as being very close to the projector, a significant delay may be introduced between estimations to allow time for the object to move away from the projector. During the period between estimations, the projector would continue to operate in the proximity detection mode of operation. In contrast, if no object is detected in front of the projector, then the controller may attempt to detect and estimate the distance to the object on a more frequent basis in order to ensure that an object is immediately detected when it moves in front of the projector. In one or more embodiments, the frequency of distance estimation may depend on the anticipated speed of objects, the typical dwell time of objects in front of the projector, and the amount of power consumption, in addition to other factors.

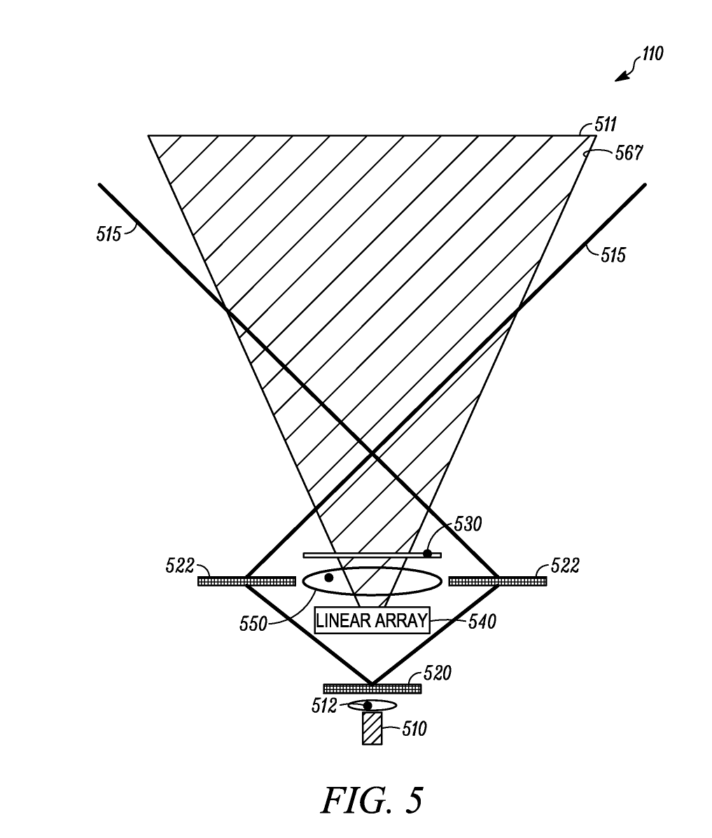

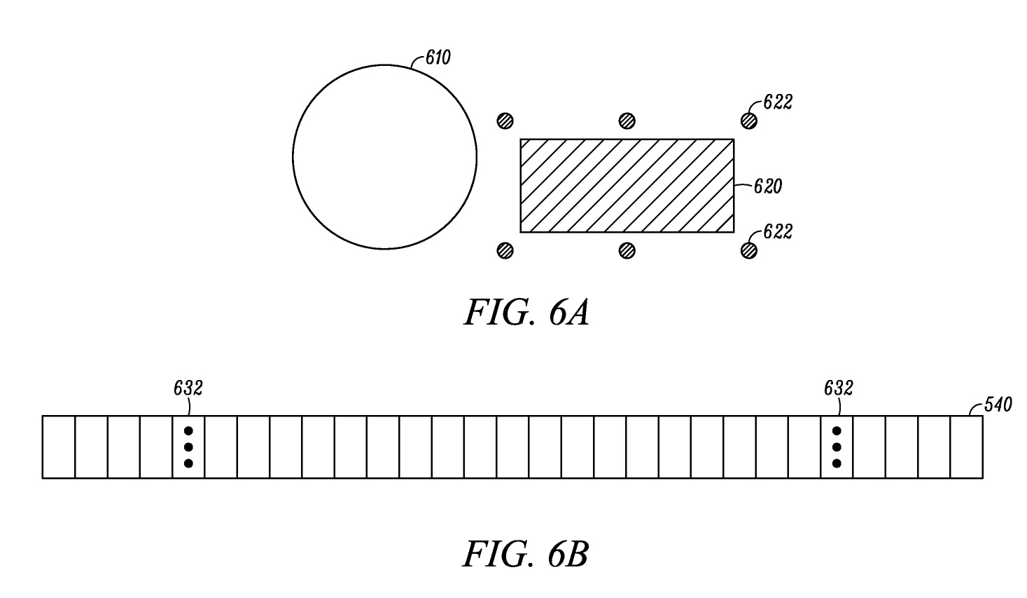

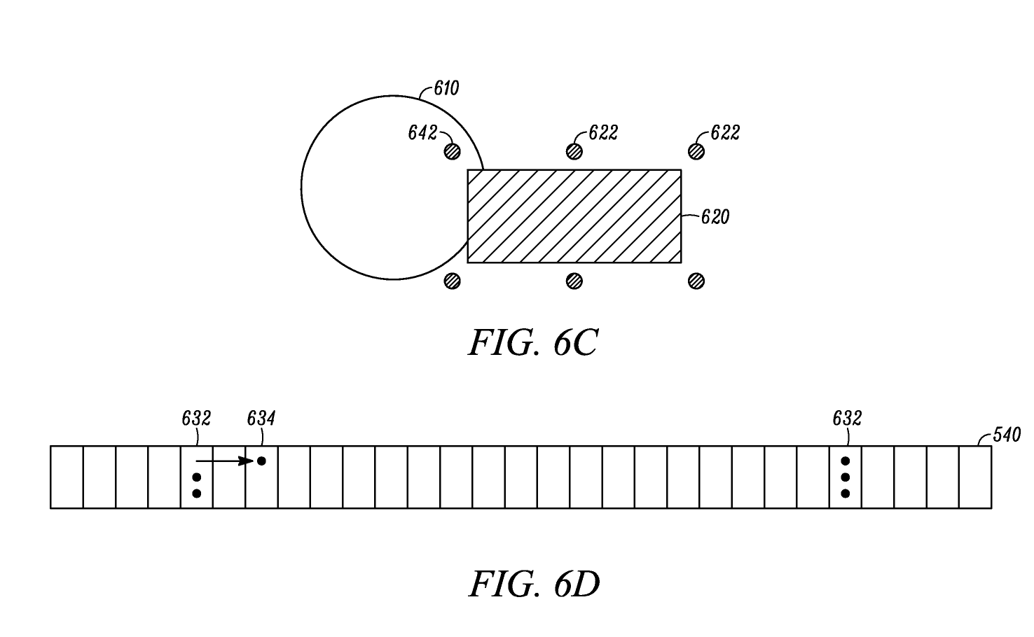

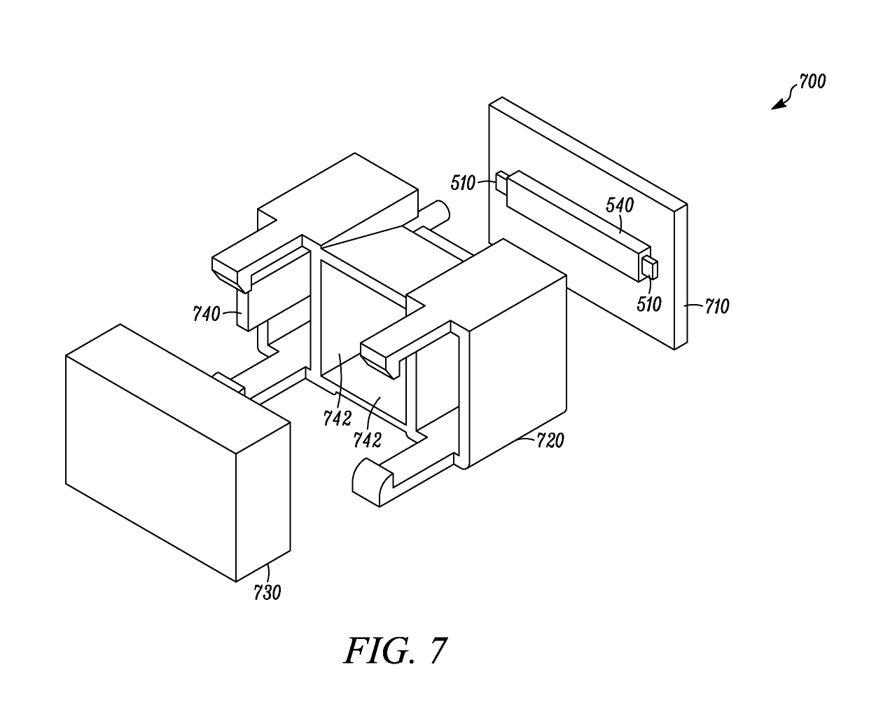

Referring now to FIG. 5, a block diagram of a top view of a proximity detector 110 configuration that uses periphery sensing to detect the presence of an object in front of the projector in accordance with one or more embodiments will be discussed. The proximity detector 110 contains an infrared emitter 510, for example a vertical cavity surface emitting laser (VCSEL) that emits infrared radiation at an approximate wavelength of 850 nm, a collimating lens 512 that collimates radiation emitted by the infrared emitter 510, a hologram 520 that splits a received beam from the infrared emitter into two intermediate beams, and two additional holograms 522 that each split a received intermediate beam from the hologram 520 into three beams, giving a total of six emitted infrared beams 515 in one particular embodiment. As shown in FIG. 6, the three beams emitted from each hologram 522 are separated in a vertical dimension, thereby causing the three beams to appear as a single line in the figure. In some embodiments, the proximity detector 110 may use two or more infrared emitters 510 instead of the single emitter and hologram 520 in order to emit infrared beams to the holograms 522. When two emitters are used, hologram 520 may be omitted and separate beams projected directly from each emitter to each hologram 522.

The proximity detector 110 projects nearly collimated beams of infrared light to create spots that are placed around a display region projected by a projector. The infrared beams are reflected off of the surface on which a projection cone 310 as shown in FIG. 3 is being projected by a projector 120 of FIG. 3, or by any intervening object that is interposed between the projector and the display surface. The reflected beams are then detected by a linear array 540 of sensors which detects reflections of the beams 515 within a detection cone 511. In one or more embodiments, the angle of detection cone 511 is different than the angle of beams 515 so that a change in the reflected beams may be detected by linear array 540 in the event a proximate object or surface is detected by proximity detector 110. An infrared filter 530 and a receiver lens 550 may be placed in front of the linear array 540 to filter unwanted radiation, such as any radiation not associated with emitted infrared beams 515, and to collimate any received beams in order to improve the detection of the reflected beams.

In one or more embodiments, the proximity detector 110 projects the infrared beams 515 to land at the periphery of the projection cone 310 emitted by the projector 120. Such a configuration allows the proximity detector to detect objects near or within the projection cone 310. The infrared beams 515 may fall outside the projection cone 310, at the edge 567 of the projection cone 310, and/or within the projection cone 310. The beams may be projected so that they are spaced roughly evenly around the periphery of projection cone 310 of FIG. 3, or the beams may be irregularly arrayed around the periphery. The use of beams of an infrared wavelength means that the image being displayed by the projector will not be impacted or degraded by the beams even if there is an overlap between the beams and the displayed image.

An object that moves between the projector and the projected surface will intersect the array of projected beams 515 and cause a change in the reflected beam pattern. In one or more embodiments, the proximity detector 110 projects the infrared beams 515 at different angles than the field of view of linear array 540 or other detector, where the field of view of linear array 540 may be represented by detection cone 511, in order to facilitate detection of a proximate object. Movement of an object in front of the proximity detector 110 causes the projected spots to translate or otherwise exhibit a detectable change, that is to move as viewed by linear array 540. Such translation is capable of being detected and/or measured by linear array 540 and/or any other receiver or detector to detect when an object is within the display region projected by the projector 120 and/or the region encompassed by the projected beams 515, although the scope of the claimed subject matter is not limited in these respects.

Referring now to FIGS. 6A-6D, block diagrams illustrating the operation of the periphery detection proximity detector in accordance with one or more embodiments will be discussed. FIGS. 6A-6B depict a normal mode of operation of a projector where an object is not in front of a scanned display region. FIG. 6A is a view of the projected image as seen from the projector, and depicts a scanned display region 620 surrounded by six projected infrared spots 622. An object 610, such as the head of a person, is depicted to the left of the scanned display region 620, but outside of the projected display region 620. FIG. 6B is a block diagram of a linear detection array 630 comprised of 29 receiving elements as one example. The object 610 does not block the scanned display region 620 or peripherally placed infrared spots 622. As a result, the infrared spots are reflected by the projection surface and fall on or near the linear detection array 630 at two locations 632 that indicate a normal mode of operation. In one or more embodiments, the linear detection array 630 may have a greater or lesser number of receiving elements, depending on the particular application in which the proximity detector 110 is being used.

FIGS. 6C-6D depict an obstructed mode of operation of a projector where an object is in front of a scanned display region. FIG. 6C is a view of the projected image as seen from the projector 120, and FIG. 6D is a block diagram of the linear detection array 540 with the received reflected beams. The object 610 has moved and now blocks the scanned display region 620 and a corner spot 642 of the infrared spots 622. Most of the infrared spots are imaged onto the linear array 630 at receiving elements 632 that indicate normal operation. However, the corner spot 642 intercepts with the object 610, causing the imaged corner spot to translate a reflected beam and be received by the linear array at a different receiving element 634. The movement of the reflected beam indicates a potentially undesirable mode of operation due to the blocking object 610, so the proximity detector 110 may modify or disable the projector 120 to ensure the continuous operation of the device.

The linear array 540 receives the translation as analog data, and may digitize the data or may leave the data as analog depending on how signals are processed by the proximity detector 110. In one or more embodiments, any number of signal processing routines may be employed by the proximity detector 110 to determine whether the projector 120 should be operated in a normal or a proximity detection mode of operation. In a normal mode of operation, projector 120 may be allowed to operate normally at normal power levels. In a proximity detection mode of operation, the power output of projector 120 may be altered, for example by reducing the power, or may be shut off altogether, at least momentarily, and/or at least until object 610 is no longer proximate to projector 120. In some embodiments, using a linear array 540 enables the proximity detector 110 to utilize on alignment techniques that do not need to be optimized in their precision, thereby avoiding the high costs attributed to calibration and alignment procedures.

The proximity detector 110 may project two or more infrared spots at a periphery of a scanned display region 620 depending on the particular projector application with which the proximity detector is used. Projecting fewer spots 622, such as one spot at each corner of the display region 620, may allow objects to intersect with a small portion of the display region during a normal mode of operation. Conversely, projecting many spots, such as one spot at each corner and two spots at each side of the display region 620, may prevent intersection of an object 610 with the display region. Additionally, the number, shape and direction of the emitted infrared beams 515 depends on different design parameters, including the type of emitters and detectors used, the direction that the emitters and detectors are oriented in a mounting, the presence or absence of any masking structures in the mounting, and other factors. In one or more embodiments the design parameters may be modified to produce emitted infrared beams 515 having a shape and direction that are optimized for the particular application in which the proximity detector 110 is used.

The proximity detector 110 can also detect when one or more components have failed and/or are not functioning as expected. In some embodiments, there may be a partially reflective element placed on or near a hologram that reflects a portion of a transmitted beam of infrared radiation onto the linear array. When the infrared emitter 510 does not operate correctly the linear array 540 will fail to detect the reflected beam and may shut down the projector 120 and/or take other remedial action.

Referring now FIG. 7, an exploded diagram illustrating a proximity detection module that uses periphery detection in accordance with one or more embodiments will be discussed. FIG. 7 depicts a mounting fixture 700 that may be used to hold many of the components that make up the proximity detector. The mounting 700 contains a back plate 710 upon which is affixed two infrared emitters 510 and light reception sensors configured in a linear array 540. The infrared emitters 510 may be placed at each end of the linear array 540 of light reception sensors. The mounting fixture 700 also contains a housing 720 that facilitates output of the infrared emitters 510 by ensuring that infrared radiation from one emitter is not mixed with infrared radiation from the other emitter before emission from the proximity detector. The housing 720 holds a cover 730 that may protect the emitters 510 and linear array 540. The housing 720 may also contain beam splitting elements (not shown), such as holographic elements, that cause beams emitted from the infrared emitters 510 to split and form additional beams. Housing 720 may further contain one or more fold mirrors 742 to redirect one or more of the beams onto linear array 540. The use of a housing may ensure accurate alignment of beam splitting elements without having to rely upon manual adjustment and/or calibration.

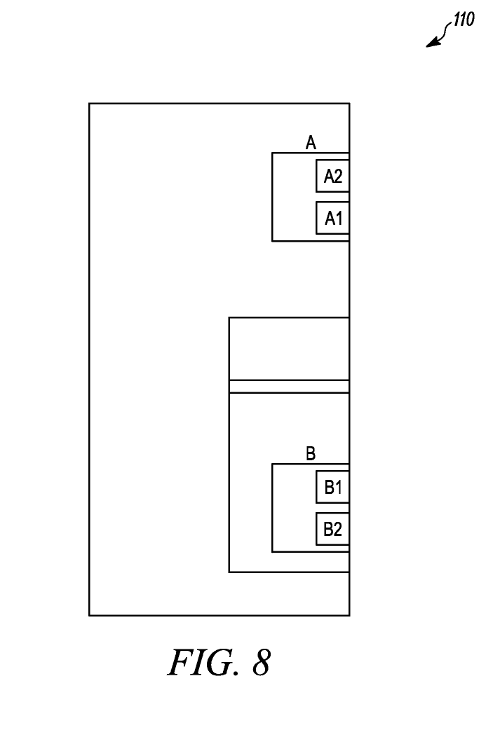

Referring now to FIG. 8, a block diagram illustrating a proximity detector that uses triangulation based distance estimation in accordance with one or more embodiments will be discussed. FIG. 8 depicts a block diagram of a proximity detector 110 configuration that uses triangulation-based estimation to detect the presence of an object in front of the projector. The proximity detector 110 contains two emitter/detector sensors A and B. Each emitter/detector sensor contains one emitter and two detectors. In some embodiments, the emitter/detector function can be combined into a single device. Thus, in the depicted embodiment, emitter/detector sensor A contains one emitter/detector A1 and one detector A2, and emitter/detector sensor B contains one emitter/detector B1 and one detector B2. Emitter/detectors A1 and B1 emit infrared radiation in the same direction as the projected light from the projector. Detectors A1, A2, B1 and B2 act to detect any radiation that is reflected by an object that enters the projection cone of the projector, or by a surface on which an image is projected by the projector.

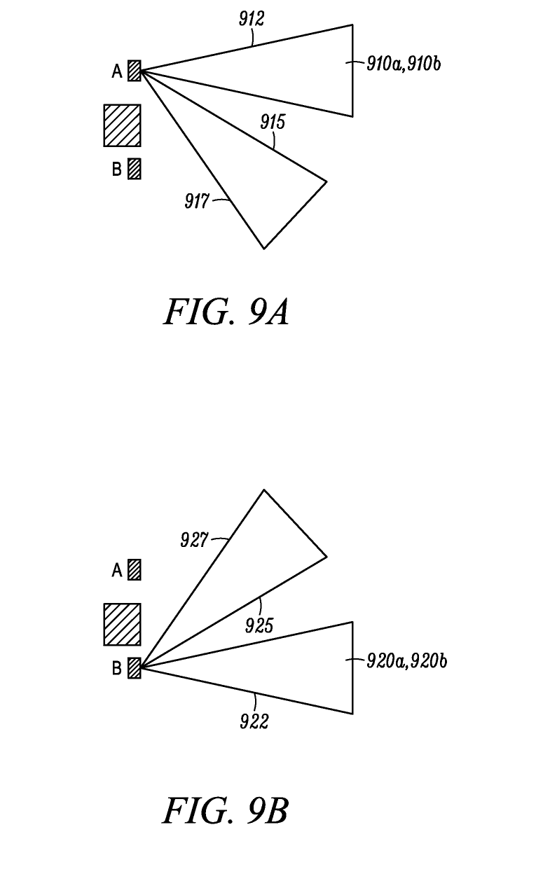

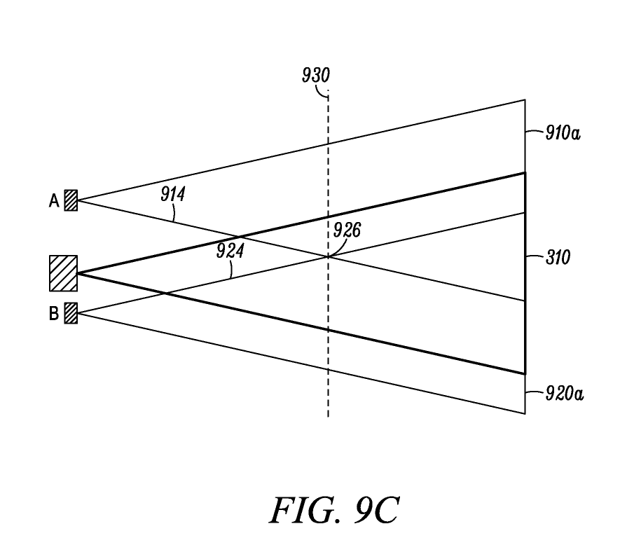

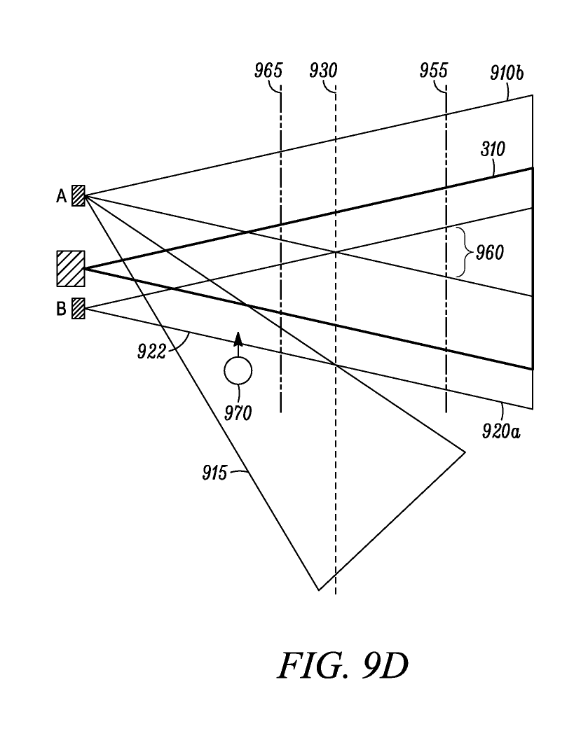

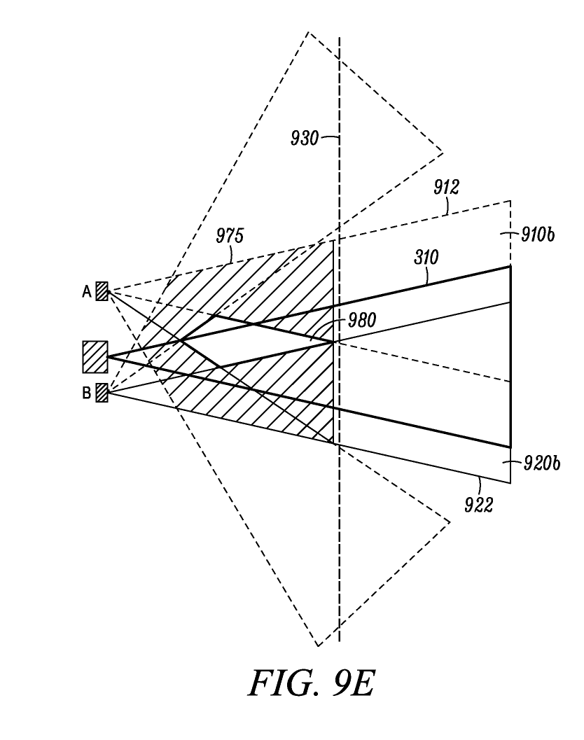

In some embodiments, emitter/detector A1 may be configured to emit infrared radiation at a certain modulation, and detectors B1 and B2 may be configured to detect the modulated infrared radiation from A1 that is reflected from an object or a surface. Similarly, emitter/detector B1 may be configured to emit infrared radiation at a certain modulation, and detectors A1 and A2 may be configured to detect the reflected modulated infrared radiation. By modulating the emitted radiation using a known modulation scheme, the detectors are able to accurately identify the source of the reflected radiation. Further details of the operation of the proximity detector 110 will now be described with respect to FIGS. 9A-9E.

Referring now to FIGS. 9A-9E, block diagrams illustrating the operation of a triangulation-based proximity detector in accordance with one or more embodiments will be discussed. FIGS. 9A and 9B depict emission and detection cones that are created by emitter/detector sensors A and B. An emission cone represents the area over which modulated infrared radiation is projected by an emitter in the emitter/detector sensor. As depicted in FIG. 9A, emitter/detector sensor A is configured to produce an emission cone 910a. The emission cone 910a extends roughly parallel to the projection cone of the projector so that it intersects the base of the projection cone (i.e., where the image is displayed). Simultaneously, as depicted in FIG. 9B, emitter/detector sensor B is configured to produce an emission cone 920a. The emission cone 920a also extends roughly parallel to the projection cone of the projector so that it intersects the base of the projection cone.

FIGS. 9A and 9B also depict detection cones that are created by emitter/detector sensors A and B. A detection cone represents the area from which reflected infrared radiation may be detected by a detector in the emitter/detector sensor. As depicted in FIG. 9A, emitter/detector sensor A is configured to produce a first detection cone 910b and a second detection cone 915. The first detection cone 910b extends roughly parallel to the projection cone of the projector so that it intersects the base of the projection cone, where the image is displayed, while the second detection cone 915 extends at an angle such that it crosses a lateral surface of the projector projection cone. The emitter/detector sensor A therefore forms a wide area of detection that extends from the left boundary 912 of the first detection cone 910b to the right boundary 917 of the second detection cone 915. Simultaneously, as depicted in FIG. 9B, emitter/detector sensor B is configured to produce a first detection cone 920b and a second detection cone 925. The first detection cone 920b extends roughly parallel to the projection cone of the projector so that it intersects the base of the projection cone, while the second detection cone 925 extends at an angle such that it crosses a lateral surface of the projector projection cone. Thus, emitter/detector sensor B forms a wide area of detection that extends from the right boundary 922 of the first detection cone 920b to the left boundary 927 of the second detection cone 925.

The shape and direction of the emission and detection cones of the emitter/detector sensors depends on a number of different design parameters, including the type of emitters and detectors used, the direction that the emitters and detectors are oriented in the proximity detector mounting, the presence or absence of any masking structures in the proximity detector mounting, and other factors. In one or more embodiments the design parameters may be modified to produce emission and detection cones having a shape and direction that is optimized for the particular application in which the proximity detector is used. In particular, while the emission cones 910a, 920a and detection cones 910b, 920b are depicted as overlapping in FIGS. 9A and 9B, it will be appreciated that the emission cones and detection cones do not need overlap and either the emission cone or detection cone may be larger than the other.

The two emission cones extending from emitter/detector sensors A and B that intersect the base of the projector projection cone 310 overlap in a manner that defines a proximity limit. FIG. 9C depicts the overlap of emission cone 910a and emission cone 920a. The inner boundary 914 of emission cone 910a intersects with the inner boundary 924 of emission cone 920a at a point 926. A line drawn perpendicular to the transmission path of the light in the projection cone 310 and through the intersection point 926 defines a proximity limit 930. As will be described in additional detail herein, the proximity detector is configured so that the proximity limit 930 coincides with the minimum distance from the projector. Objects that enter the projection cone between the proximity limit and the projector are too close to the projector. The proximity detector is therefore configured to detect the entering object and cause the projector to enter a proximity detection mode of operation.

FIG. 9D depicts the proximity detection operation of the emitter/detector sensor A. The emitter/detector sensor can detect an object entering a detection zone, as well as the presence or absence of a surface at a desired distance. The detection cone 910b defines a region where a surface may be detected to ensure that there is some surface (e.g., a wall, a screen, etc.) that can receive the projected image in projection cone 310. If a surface is located at position 955, beyond the proximity limit 930, then the detector associated with the detection cone 910b will detect infrared radiation that is transmitted from the emitter/detector sensor B and reflected from the surface. The received radiation is modulated with the unique modulation associated with the emitter/detector sensor B, and reflected from at least a segment 960 of the surface. If a surface is detected beyond the proximity limit, and other issues are not otherwise detected, then the projector may be allowed to operate in the normal mode of operation. In contrast, if a surface is located at a position 965, within the proximity limit, then the detector associated with the detection cone 910b will not be able to detect infrared radiation from the emitter/detector sensor B reflected from the surface. Such radiation cannot be detected because the intersection of the detection cone 910b with the surface at surface position 960 does not overlap the intersection of the emission cone 920a with the surface at surface position 960. When the surface cannot be detected in such a fashion, then the projector is placed into the shut off mode of operation since the surface is too close to the projector. A similar result occurs if the surface is too far away from the projector. If the surface is far enough away from the projector that insufficient radiation is reflected for purposes of detection, the shut off mode of operation may also be triggered since there is no surface on which to project an image of a desired quality.

The detection cone 915 is used to detect the proximity of an object 970 to the lateral boundary of the projection cone 310. If object 970 crosses the right boundary 922 of the emission cone 920a at a location within the proximity limit, then infrared radiation from emitter/detector sensor B is reflected off of the object. The reflected radiation is detected by the detector associated with the detection cone 915. Such radiation can be detected because of the intersection of the detection cone 915 with the emission cone 920a. When the object is detected in such a fashion, the projector is placed into the shut off mode of operation since the object is too close to the projector. In contrast, if the object were to cross the right boundary 922 of the emission cone 920a at a location outside of the proximity limit, such a crossing would not be detected by the proximity detector because the detection cone 915 does not intersect with the emission cone 920a outside of the proximity limit. This condition does not need to be detected as the proximity limit is set so that any intersection with the projection cone 310 outside of the proximity limit is considered normal. The logic associated with the operation of the emitter/detector sensor A is represented in Table 1.

TABLE 1

| Detection cone | Detection cone | | |
|---|---|---|---|
| 910b | 915 | Condition | Mode |
| 1 | 0 | Normal operation, absent | Normal |
| | | other conditions | |
| 0 | X | Projection surface too | Proximity |
| | | close, too far, or missing | Detection |
| X | 1 | Object too close to right | Proximity |
| | | lateral edge of projection | Detection |
| | | cone | |

FIG. 9D depicts sensor A at a greater distance from the projector than sensor B. In one or more embodiments, the sensors may be placed any distance from the projector, provided that the detection cones overlap the appropriate emission cone and projection cone over a desired range. The sensors may be equidistant from the projector, or unevenly spaced from the projector. The spacing and angle of the emission/detection cones are selected to create the desired zone of detection necessary to ensure operation of the projector.

While FIG. 9D is directed to proximity detection of emitter/detector sensor A, emitter/detector sensor B operates in an analogous fashion. Detection cone 920b is used to determine whether a surface is present to receive the projected image in projection cone 310. Detection cone 925 is used to detect whether an object crosses the left boundary of the emission cone 910a at a location within the proximity limit. The logic table for the operation of emitter/detector sensor B is reflected in Table 2.

TABLE 2

| Detection cone | Detection cone | | |
|---|---|---|---|
| 920b | 925 | Condition | Mode |
| 1 | 0 | Normal operation, absent | Normal |
| | | other conditions | |
| 0 | X | Projection surface too | Proximity |
| | | close, too far, or missing | Detection |
| X | 1 | Object too close to right | Proximity |
| | | lateral edge of projection | Detection |
| | | cone | |

FIG. 9E depicts a detection zone 975 that is formed when emitter/detector sensors A and B are in operation. Detection zone 975 is bounded by the proximity limit 930, the left boundary 912 of detection cone 910b, and the right boundary 922 of detection cone 920b. Objects that cross into the detection zone 975 are detected by the proximity detector. When the object is detected, the projector is caused to turn off or project images with less intensity. A gap 980 in the detection zone 975 may vary in size, and in certain configurations may not exist if the sensor configuration is designed to provide a desired overlap. In configurations where the gap is present, the size of the gap is selected to be smaller than the smallest object that needs to be detected when it crosses into the detection zone. For example, the gap may be sized so that it is smaller than the head of a pet such as a cat or small dog.

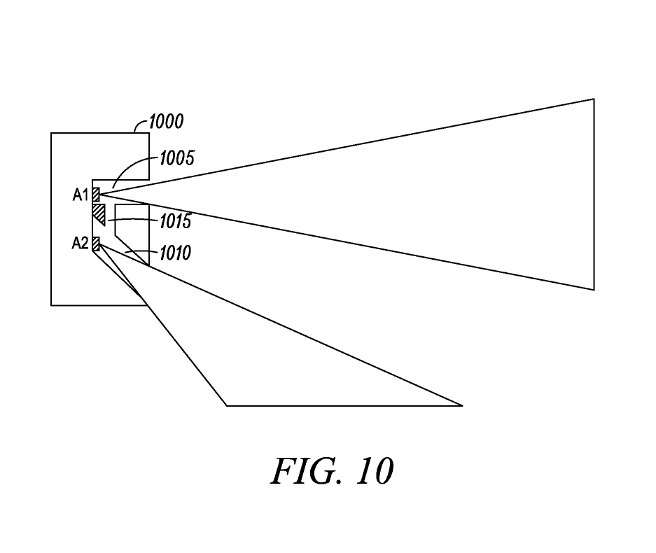

Referring now to FIG. 10, a cross-section of a mounting fixture for the triangulation-based proximity detector in accordance with one or more embodiments will be discussed. In addition to being able to detect the presence of an object within the detection zone, each detector in the emitter/detector sensor is able to detect the correct operation of the corresponding emitter in the sensor. Such a condition may arise when one or more of the infrared emitter/detector components A or B are blocked (such as by a user's finger), when an emitter has failed, when a detector has failed, when controlling or other components have failed, and so on. FIG. 10 depicts a cross-section of a representative mounting fixture 1000 for an emitter/detector sensor A. The mounting fixture is comprised of a first cylindrical or rectangular cavity 1005 having an emitter/detector A1 at its base, and a second cylindrical or rectangular cavity 1010 having a detector A2 at its base. The position of each sensor and the width and depth of each cavity establishes the size and shape of the emission or detection cone that extends from the emitter/detector or detector. The received or emitted radiation is masked by the walls of the mounting fixture, thereby defining the shape of the emission and detecting cones. The mounting fixture may be accurately formed in a low-cost fashion, thereby reducing the overall cost of the proximity detector because the emitter/detectors and detectors do not need to have precise emission or detection patterns. Connecting the first cavity with the second cavity is a coupling passage 1015. The coupling passage enables radiation from the emitter/detector A1 to reach the detector A2. In operation, if the radiation from the emitter is not detected by the detector A2, then it is likely that an error condition exists in either the emitter or the detector. Because the proximity detector typically should be constantly operating to ensure that there are no object interference issues from the projected light, when an error condition is detected in the sensor the projector is immediately placed into the shut off mode out of an abundance of caution. The radiation from the emitter/detector A1 must also be detected by the detector in emitter/detector A1 after being reflected from the projection surface. If the detector A1 is unable to detect the reflected radiation from the emitter, the projector is immediately placed into the shut off mode out of an abundance of caution. A similar error detection scheme is implemented for the B sensor to ensure that the B1 and B2 emitters and detectors are always operational. The following Table 3 presents the logic for the further proximity detection check provided by the emitter/detector sensors:

TABLE 3

| | | Detector | | | |
|---|---|---|---|---|---|
| Detector A1 | Detector A2 | B1 | Detector B2 | Condition | Mode |
| 0 | X | X | X | Fault in A sensor | Proximity Detection |
| X | 0 | X | X | Fault in A sensor | Proximity Detection |
| X | X | 0 | X | Fault in B sensor | Proximity Detection |
| X | X | X | 0 | Fault in B sensor | Proximity Detection |
| 1 | 1 | 1 | 1 | Normal operation | Normal |

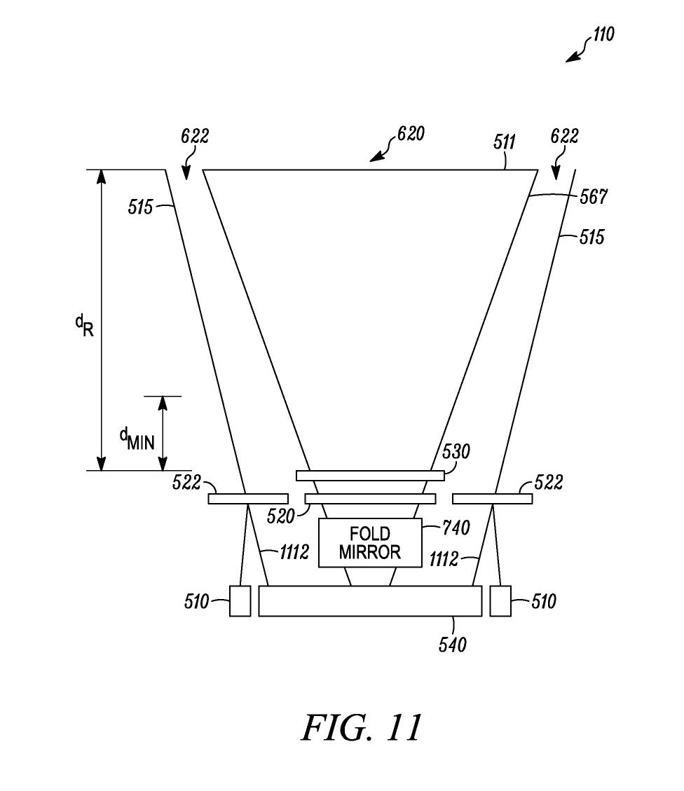

Referring now to FIG. 11, a block diagram illustrating an alternative embodiment of a proximity detector that uses periphery detection in accordance with one or more embodiments will be discussed. As shown in FIG. 11, proximity detector 110 may comprise two or more VCSELS 510 capable of emitting beams 515 of laser light. In one or more embodiments, the laser light emitted from VCSELS 510 comprises infrared (IR) light having a wavelength of about 850 nm, although devices emitting other types of light and/or radiation may be utilized such as light emitting diodes (LEDs) or other light sources capable of emitting beams 515 of light at other wavelengths, and not necessarily laser light or collimated light, and the scope of the claimed subject matter is not limited in this respect. In the embodiment of proximity detector 110 shown in FIG. 11, beams 515 emitted from VCSELS 515 may be controlled via holograms 522, and in particular the beams 515 do not cross as with the embodiment of proximity detector 110 shown in FIG. 5 in which beams 515 do cross. However, it should be noted that the scope of the claimed subject matter is not limited in this respect.

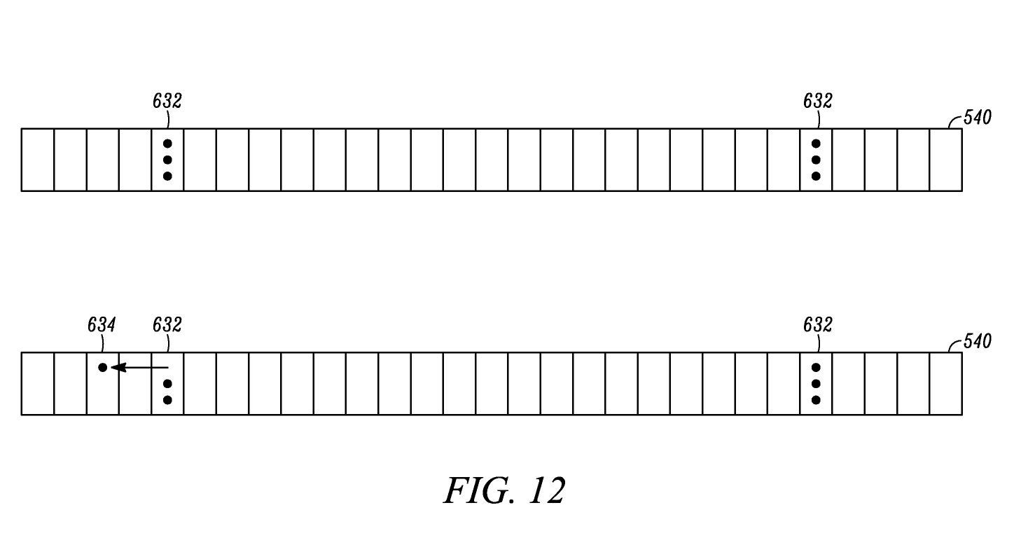

As shown in FIG. 11, spots 622 resulting from beams 515 may be imaged onto linear array 540 by capturing a reflected image of spots 622 through an infrared (IR) filter 530, which may comprise a narrow band and/or band pass filter at or near the wavelength of beams 522, for example, through hologram 520, and through fold mirror 740. Hologram 522 is capable of splitting one beam emitted from VCSEL 510 into three beams 515 at a predetermined angle with respect to projection cone 310. In one or more embodiments, the beams emitted by VCELS 510 are at or near a wavelength of 850 nm which falls in the infrared (IR) spectrum, although the scope of the claimed subject matter is not limited in this respect. It should be noted that beams 515 at or near the 850 nm are capable of reflecting off the skin of a user so that if object 610 happens to be part of the body of a user, proximity detector 110 is capable of detecting the presence of the body part of the user in the operating range of projector 120. The IR filter 530 is utilized to reject ambient light and to select light at or near the wavelength of beams 515. As shown in FIG. 6A-6D, holograms 522 may cause beams 515 to project six spots 622 with three spots disposed outside of display rejection 620 of projection cone 310, lying just outside of the edge 567 of projection cone. The image of spots 622 may be controlled by hologram 520 and/or fold mirror 740 to cause all six spots 622 to be imaged upon linear array 540 as shown in and described with respect to FIG. 6B and FIG. 6C, and/or with respect to FIG. 12, below. In one particular embodiment, the outside spots 622 are reflected onto linear array via fold mirror 740 and the inside spots are not reflected by fold mirror 740.

It should be noted that in one or more embodiments, the field of view of linear array 540, represented as detection cone 511, is disposed at an angle that is at least slightly different than the angle of beams 515 emitted from VCSELS 510 of proximity detector 110 to result in a parallax difference between the two angles. Such a parallax allows for triangulation to be utilized for detecting an object disposed in proximity to projector 120 so that the operation of projector 120 may be altered in response to proximity detector 110 detecting a proximate object. In one or more embodiments, proximity detector 110 is capable of detecting an object disposed at or within a minimum operational distance d_{MIN} from projector 120. In one particular embodiment, the minimum operational distance is 15 mm, and proximity detector 110 is optimized to detect objects within an operational range d_{R} where the operational range is 100 mm from projector 120. In one or more embodiments, if an object is disposed within the detection cone 511 but at a distance beyond 100 mm from projector 120, proximity detector 110 may be capable of detecting the object but proximity detector 110 may optionally take no action in response to the presence of the object since the optical power of the light from projector 120 may be sufficiently low to not have any deleterious effects on the object, however the scope of the claimed subject matter is not limited in this respect.

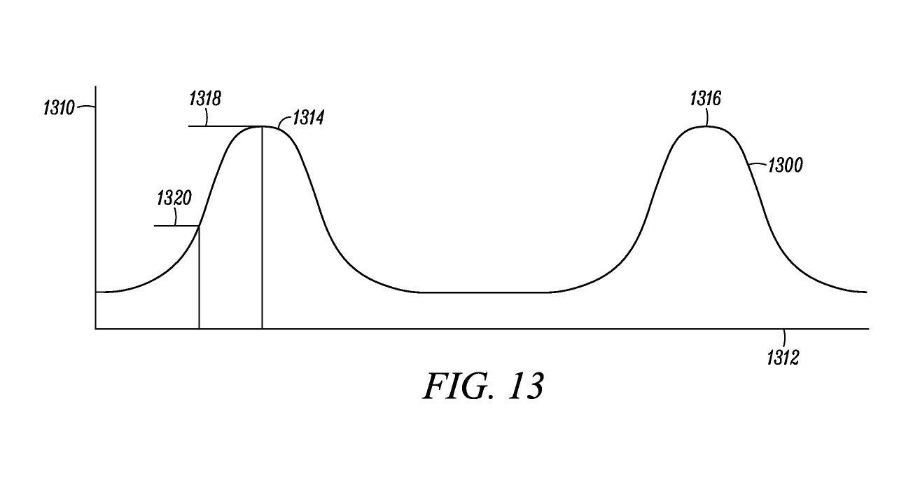

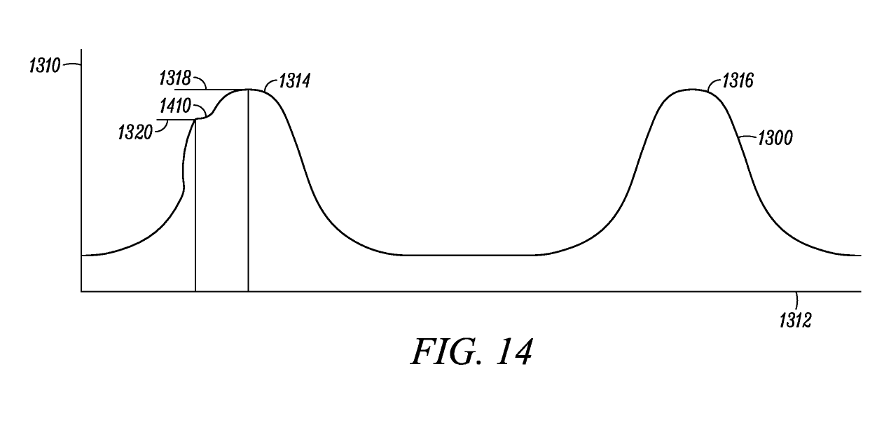

Referring now to FIG. 12, a block diagram illustrating the operation of the embodiment of a proximity detector as shown in FIG. 11 in accordance with one or more embodiments will be discussed. The linear array 540 as shown in FIG. 12 operates in substantially the same manner as the linear array 540 of FIGS. 6B and 6D, except that since beams 515 cross in the embodiment of proximity detector 110 of FIG. 5 but do not cross in the embodiment of FIG. 11, spots 632 will translate inward along linear array 540 as the surface of reflection of the spots 632 is moved closer to projector 120 if the beams cross, and spots 632 will translate outward along linear array 540 as the surface of reflection is moved closed to projector 120 if the beams do not cross. Thus, if an object is disposed within the operating range of proximity detector 110 as shown in FIG. 6C, thereby blocking one of the six beams 515, so that the corresponding beam 515 is reflected off of the interposing object, that beam's spot 632 will translate outward along linear array 540 away from the other spots 532 as shown in FIG. 12 corresponding to the embodiment of proximity detector 110 of FIG. 11 where beams 515 do not cross. The corresponding change in the output of linear array 540 is shown in and described with respect to FIG. 13 and FIG. 14, below.

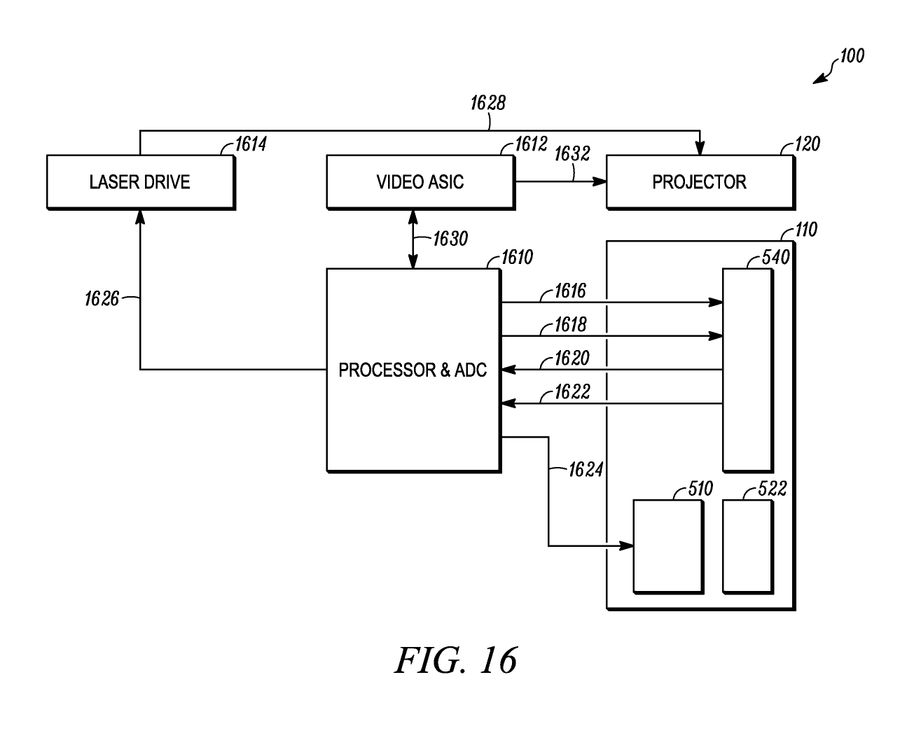

Referring now to FIG. 13, a plot of the output of a linear array of a proximity detector in accordance with one or more embodiments will be discussed. As shown in FIG. 13, plot 1300 corresponds to the output of linear array 540 during normal operation, for example when display region 620 is projected onto a surface and beams 515 also reflect off that surface when no object is disposed within the operating range of projector 120. In one or more embodiments, the y-axis 1310 represents the output of linear array 540, and the x-axis represents the position of the given output along linear array 540. During operation of proximity detector 110, photons from the reflection of beams 515 that impinge on linear array 540 are collected to cause charge to accumulate at those locations of linear array 540. Corresponding circuitry, as shown in and described with respect to FIG. 16, below, integrates the charge accumulated on linear array 540 and then generates a signal to provide an output corresponding to 1300. The output of linear array 540 having two peaks as shown in FIG. 13 is valid when all beams 515 are blocked by a plane normal to the apex of the beams, for example by a surface or viewing screen onto which display area 620 is projected. If no object is disposed in the operating range of projector 120 and the beams 515 are reflected off of such a plane, plot 1300 generally appears as shown in FIG. 13 in which two peaks 1314 and 1316 may be seen corresponding to locations 632 of the two groups of three spots 622 on linear array 540. The array circuitry periodically reads out the charge stored on linear array 540 to regenerate plot 1300. In order to determine if an object 610 is disposed in the operating range of projector 120, thereby causing translation of one or more of the spots 622 along linear array 540, a threshold level may be set for detecting such an event. In one or more embodiments, a maximum level 1318 may be determined for each plot 1300 obtained from a reading out linear array 540. The threshold level may be set at a level 1320 to approximately 13.5% of the maximum level 1318, which corresponds approximately to e⁻², although the scope of the claimed subject matter is not limited in this respect. The threshold level 1320 corresponds to the furthest out pixel in linear array 540 away from the pixel corresponding to maximum level 1318. If an output of the linear array 540 is detected beyond this furthest out pixel at threshold level 1320, proximity detector 110 may determine that one or more spots 622 from beams 515 have migrated a sufficient distance to indicate the presence of an object 610 in the operating range of projector 120.

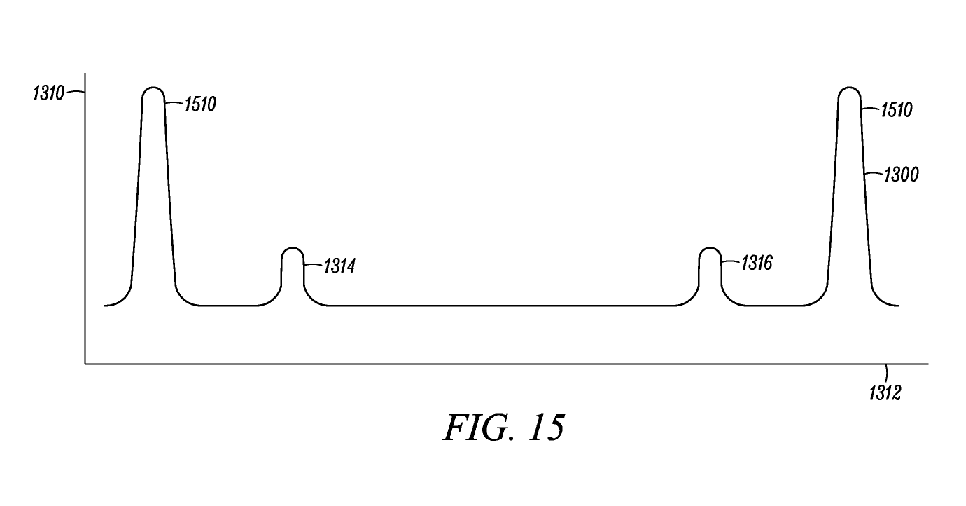

Referring now FIG. 14, a plot of the output of a linear array of a proximity detector showing the output of the linear array if an object is disposed proximate to a projector in accordance with one or more embodiments will be discussed. If an object 610 is disposed within the operating range of projector 120, one or more of beams 515 will impinge on the object 610, thereby causing the corresponding spot 622 to move along array 640 such as the displaced spot 634 shown in FIG. 12. As a result, the output of linear array 540 will change and result in plot 1300 as shown in FIG. 14. Peak 1410 may appear in plot 1300 which corresponds to the output of linear array 540 due to the displaced position of spot 634. Since the peak 1410 of plot 1300 corresponding to displaced spot 634 lies outside the threshold pixel corresponding to threshold level 1320, proximity detector 110 detects object 610 is disposed in the operating range of projector 120, and is capable of performing an appropriate action, for example but shutting down projector 120. Furthermore, in addition to determining the location of an object 610 within the operating range of projector 120, and responding according if an object 610 is so detected, proximity detector 110 may further include one or more mechanisms to shut down projector 120 in the event of one or more failure events as shown in and described with respect to FIG. 15, below.

Referring now to FIG. 15, a plot of the output of the linear array of a proximity detector showing the output of a failure detection mechanism in accordance with one or more embodiments will be discussed. The output of linear array 540 represented by plot 1300 is shown in FIG. 15 is substantially similar to plot 1300 shown in and described with respect to FIG. 13 and FIG. 14, including peaks 1314 and 1316, with the inclusion of peaks 1510 resulting from a failure detection mechanism of proximity detector 110. As shown in FIG. 11, a portion of the beams emitted by VCELS 510 is reflected off of holograms 522 as beams 1112 that impinge on linear array 540 at the ends of linear array 540. The impingement of beams 1112 on linear array 540 result in peaks 1510 in plot 1300 of FIG. 15. Peaks 1510 are located outside of peaks 1314 and 1316 on plot 1300 and relatively larger in amplitude than peaks 1314 and 1316. The presence of such peaks 1510 in plot 1300 indicates to proximity detector 110 that both VCELS 510 are operating properly. In the event that one or both of VCSELS 510 are not operating properly, for example due to failure, then the corresponding peak 1510 will not be present in plot 1300, and proximity detector 110 may take an appropriate action in response thereto, for example to shut down projector 120 since proximity detector 120 may not be able to properly detect the presence of object 610 in the operating range of projector 120 if one or more VCELS 510 is not properly functioning. In another embodiment, a failure detection mechanism may comprise determining whether peak 1314 and/or peak 1316 is present in plot 1300. In the event that one or more of peaks 1314 and/or 1316 is not present in plot 1300, display region 620 is perhaps being projected onto a surface or object located too far away from projector 120 for proximity detector 110 to properly operate and be capable of detecting the presence of an object 610 in the operating range of projector 120. In such a situation, the reflected beams 515 may result in spots 632 not impinging on linear array 540, which may not allow proximity detector 110 to operate properly. In such a situation, while not necessarily a failure of any component or system of proximity detector 110 or projector 120, proximity detector 110 may cause projector 120 to be shut down since display region 620 may be projected outside a normal operating range. Furthermore, in one or more embodiments, linear array 540 and/or one or more components in the circuitry for operating and reading the output of linear array 540 may have failed, resulting in no plot 1300 being present. In such an event, proximity detector 110 may also shut down projector 120. In general, an event or situation in which proximity detector 110 or a component thereof may not properly operate may result in the shut down of projector 120 as a precautionary measure, although the scope of the claimed subject matter is not limited in this respect.

Referring now to FIG. 16, a block diagram of a device having a projector and a proximity detector showing the control of the projector by the proximity detector in accordance with one or more embodiment will be discussed. Device 100 of FIG. 16 may correspond to device 100 of FIG. 1, with the specific components and interaction between proximity detector 110 and projector 120 being shown in FIG. 16. In one or more embodiments, proximity detector 110 is shown comprising one VCSEL 510 and hologram 522 for purposes of example, however proximity detector 110 may include two or more VCSELS 510 and/or two or more holograms 522 for example as shown in and described with respect to FIG. 11, and the scope of the claimed subject matter is not limited in this respect. Linear array 540 may receive photons from the reflection of beams 515 as discussed herein, above. Linear array 540 may be coupled with processor 1610 which may correspond to controller 144 of device 100 as shown in FIG. 1. Processor 1610 may also comprise an analog-to-digital converter (ADC), either integrated with processor 1610 or as a separate device or circuit. In one or more embodiments, linear array 540 comprises a 540 pixel array, and the ADC may comprise a 10-bit ADC. Processor 1610 may provide a clock signal 1616 and/or a reset signal to linear array 540, and may receive a sync signal 1620 and/or an output signal 1622 from linear array 540. Processor 1610 may also provide a high current drive signal 1624 to drive VCSEL 510. Processor 1610 may couple with a video ASIC 1612 via control signal 1630, which in turn controls the operation of projector 120 to display video images in display region 620 via projection cone 310 via signals 1632. Processor 1610 may provide a proximity detection signal 1626 to a laser drive circuit 1614 which controls the operation of the imaging elements of projector 120 via a drive signal 1628, which in the embodiment shown may comprise one or more lasers. In the event of an object proximity detection event and/or a failure detection mechanism, processor 1610 may provide a shut down signal to laser drive circuit 1614 via signal 1626, which in turn may cause laser drive circuit 1614 to shut down projector 120, for example by turning off drive signal 1628. In the event that the proximity detection event is no longer present, and/or the failure detection mechanism no longer indicates a failure, processor 1610 may indicate to laser drive circuit 1614 via signal 1626 to allow operation of projector 120, and laser drive circuit 1614 may activate drive signal 1628 to allow projector 120 to operate. It should be noted that the circuits and other elements shown in FIG. 16 are merely examples for the operation of device 100 via proximity detection, and that other circuits and/or arrangements of elements may likewise be implements, and the scope of the claimed subject matter is not limited in this respect.

Although the claimed subject matter has been described with a certain degree of particularity, it should be recognized that elements thereof may be altered by persons skilled in the art without departing from the spirit and/or scope of claimed subject matter. It is believed that the subject matter pertaining to proximity detection for control of imaging devices and/or many of its attendant utilities will be understood by the forgoing description, and it will be apparent that various changes may be made in the form, construction and/or arrangement of the components thereof without departing from the scope and/or spirit of the claimed subject matter or without sacrificing all of its material advantages, the form herein before described being merely an explanatory embodiment thereof, and/or further without providing substantial change thereto. It is the intention of the claims to encompass and/or include such changes.

What is claimed is:

1. A method to detect a proximate object, comprising:
projecting at least two projected beams each at a first angle;
detecting a at least one reflected beam of the at least two projected beams with a detector having a field of view disposed at a second angle, the second angle being different than the first angle; and
determining if an object is disposed in the field of view based at least in part on detecting a change in the reflected beam via the detector due to reflection of any of the at least two projected beams off the object.

2. A method as claimed in claim 1, further comprising using a projection optic to provide an emission cone for the at least two projected beams, the first angle falling within the emission cone, the emission cone establishing a range of distances for said determining.

3. A method as claimed in claim 2, the projection optic comprising a lens, a hologram, a reflector, or an aperture mask, or combinations thereof.

4. A method as claimed in claim 1, further comprising using an imaging optic to provide an acceptance cone for the reflected beam, the second angle falling within the acceptance cone, the acceptance cone establishing a range of distances for said determining.

5. A method as claimed in claim 4, the imaging optic comprising a lens, a hologram, a reflector, an aperture mask, or a shadow mask, or combinations thereof.

6. A method as claimed in claim 1, further comprising using a projection optic to provide an emission cone for the at least two projected beams, the first angle falling within the emission cone, or using an imaging optic to provide an acceptance cone for the reflected beam, the second angle falling within the acceptance cone, or combinations thereof, and the emission cone or the acceptance cone, or combinations thereof, establishing a range of distances for said determining.

7. A method as claimed in claim 1, said determining comprising obtaining a location of the object via triangulation of at least one of the two or more projected beams and a corresponding reflected beam via the detector.

8. A method as claimed in claim 1, the detector comprising a single detector element, and said detecting a change in the reflected beam comprising detecting a change in a size of the reflected beam, detecting a change in the shape of the reflected beam, or detecting a change in the location of the reflected beam via the single detector element.

9. A method as claimed in claim 1, the detector comprising an array of two or more detector elements, and said detecting a change in the reflected beam comprising detecting a change in a size of the reflected beam, detecting a change in the shape of the reflected beam, or detecting a change in the location of the reflected beam along the array of two or more detector elements.

10. A method to control a projector based on detection of a proximate object, comprising:
projecting an image as an output of a projector;
projecting a projected beam at a first angle;
detecting a reflected beam of the projected beam with a detector having a field of view disposed at a second angle, the second angle being different than the first angle;
determining if an object is disposed in the field of view based at least in part on detecting a change in the reflected beam via the detector due to reflection of the projected beam off the object; and
if an object is disposed in the field of view, adjusting the output of the projector.

11. A method as claimed in claim 10, said adjusting comprising reducing an output power of the projector, or turning off the projector.

12. A method as claimed in claim 10, said adjusting comprising reducing an output power of the projector, or turning off the projector, and further comprising subsequently increasing an output of the projector or turning on the projector, if the object is no longer disposed in the field of view.

13. A method as claimed in claim 10, said determining further comprising a determining a location of the object via triangulation of the projected beam and the reflected beam via the detector, said adjusting being based at least in part on the location of the object.

14. A proximity detector, comprising:
at least one emitter capable of emitting at least two projected beams at a first angle;
a detector capable of detecting at least one reflected beam of the at least two projected beams, the detector having a field of view disposed at a second angle, the second angle being different than the first angle; and
a processor receiving an output from the detector, the processor being capable of determining if an object is disposed in the field of view based at least in part on detecting a change in the reflected beam via the detector due to reflection of any of the at least two projected beams off the object.

15. A proximity detector as claimed in claim 14, further comprising a projection optic to provide an emission cone for the at least two projected beams, the first angle falling within the emission cone, the emission cone establishing a range of distances for the detecting of the reflected beam by the detector.

16. A proximity detector as claimed in claim 15, the projection optic comprising a lens, a hologram, a reflector, or an aperture mask, or combinations thereof.

17. A proximity detector as claimed in claim 14, further comprising an imaging optic to provide an acceptance cone for the reflected beam, the second angle falling within acceptance cone, the acceptance cone establishing a range of distances for the detecting of the reflected beam by the detector.

18. A proximity detector as claimed in claim 17, the imaging optic comprising a lens, a hologram, a reflector, an aperture mask, or a shadow mask, or combinations thereof.

19. A proximity detector as claimed in claim 14, further comprising a projection optic to provide an emission cone for the at least two projected beams, the first angle falling within the emission cone, or an imaging optic to provide an acceptance cone of angles for the reflected beam, the second angle falling within the acceptance cone, or combinations thereof, and the emission cone or the acceptance cone, or combinations thereof, establishing a range of distances for the detecting of the reflected beam by the detector.

20. A proximity detector as claimed in claim 14, the processor being capable of determining a location of the object via triangulation of any of the at least two projected beams and the reflected beam via the output of the detector.

21. A proximity detector as claimed in claim 14, the detector comprising a single detector element, the processor being capable of detecting a change in the reflected beam by detecting a change in a size of the reflected beam, by detecting a change in the shape of the reflected beam, or by detecting a change in the location of the reflected beam via the output of the single detector element.

22. A proximity detector as claimed in claim 14, the detector comprising an array of two or more detector elements, the processor being capable of detecting a change in the reflected beam by detecting a change in a size of the reflected beam, by detecting a change in the shape of the reflected beam, or by detecting a change in the location of the reflected beam via the output of the array of two or more detector elements.

23. A proximity detector as claimed in claim 14, the at least two projected beams comprising a laser beam having an infrared wavelength.

24. A proximity detector as claimed in claim 14, the emitter comprising a VCSEL.

25. A proximity detector as claimed in claim 14, further comprising a filter disposed proximate to the detector, the filter being selective to a wavelength of the at least two projected beams to reduce ambient light impinging on the detector.

26. A proximity detector as claimed in claim 14, the emitter comprising two or more light sources, the two more light sources and the detector being disposed on a common plane.

27. An apparatus to control projection of an image based on detection of a proximate object, comprising:
a projector capable of projecting an image as an output of the projector; and
a proximity detector coupled to the projector, the proximity detector comprising:
an emitter capable of emitting a projected beam at a first angle;
a detector capable of detecting a reflected beam of the projected beam, the detector having a field of view disposed at a second angle, the second angle being different than the first angle; and
a processor capable of determining if an object is disposed in the field of view based at least in part on detecting a change in the reflected beam via the detector due to reflection of the projected beam off the object, the processor being capable of adjusting the output of the projector if an object is disposed in the field of view proximate to the projector.

28. An apparatus as claimed in claim 27, the processor being capable of reducing an output power of the projector, or turning off the projector.

29. An apparatus as claimed in claim 27, the processor being capable of reducing an output power of the projector, or turning off the projector if the object is disposed in the field of view, and further being capable of subsequently increasing an output of the projector or turning on the projector, if the object is no longer disposed in the field of view.

30. An apparatus as claimed in claim 27, further comprising an optical element capable of splitting the projected beam into two or more beams projected along a periphery of the image to result in two or more reflected beams capable of being detected by the detector, the projected beams being projected along the periphery of the image over a predetermined range of projection of the image.

31. An apparatus as claimed in claim 27, the emitter comprising two or more light sources, the two more light sources and the detector being disposed on a common plane.

32. An apparatus as claimed in claim 27, the processor being further capable of adjusting the output of the projector if the reflected beam is not at least partially detected by the detector.

33. A portable device, comprising:
a radio-frequency circuit capable of communicating via radio-frequency communications;
a projector capable of projecting an image received via the radio-frequency circuit as an output of the projector; and
a proximity detector coupled to the projector, the proximity detector comprising:
an emitter capable of emitting a projected beam at a first angle;
a detector capable of detecting a reflected beam of the projected beam, the detector having a field of view disposed at a second angle, the second angle being different than the first angle; and
a processor capable of determining if an object is disposed in the field of view based at least in part on detecting a change in the reflected beam via the detector due to reflection of the projected beam off the object, the processor being capable of adjusting the output of the projector if an object is disposed in the field of view proximate to the projector.

34. A portable device as claimed in claim 33, the processor being capable of reducing an output power of the projector, or turning off the projector.

35. A portable device as claimed in claim 33, the processor being capable of reducing an output power of the projector, or turning off the projector if the object is disposed in the field of view, and further being capable of subsequently increasing an output of the projector or turning on the projector, if the object is no longer disposed in the field of view.

36. A portable device as claimed in claim 33, further comprising an optical element capable of splitting the projected beam into two or more beams projected along a periphery of the image to result in two or more reflected beams capable of being detected by the detector.

37. A portable device as claimed in claim 33, the processor being capable of determining a location of the object via triangulation between the projected beam and the reflected beam via the output of the detector.

38. A portable device as claimed in claim 33, the emitter comprising two or more light sources, the two more light sources and the detector being disposed on a common plane.

39. A portable device as claimed in claim 33, the processor being further capable of adjusting the output of the projector if the reflected beam is not at least partially detected by the detector.
